(19) United States
(12) Patent Application Publication
(10) Pub. No.: US 2012/0067348 A1
(43) Pub. Date: Mar. 22, 2012

(54) BREATHING APPARATUS SYSTEM

(76) Inventors: Jeremy A. Steck, Salt Lake City, UT (US); Layton Wise, Washington, PA (US); Michael Rupert, Sarver, PA (US); Benjamin Mauti, Seven Fields, PA (US)

(21) Appl. No.: 13/070,914

(22) Filed: Mar. 24, 2011

Related U.S. Application Data
(60) Provisional application No. 61/317,161, filed on Mar. 24, 2010.

(51) Int. Cl. A62B 7/02; A62B 9/04; A62B 18/02

(52) U.S. Cl. 128/205.22; 128/204.18; 128/205.25

(57) ABSTRACT

A breathing apparatus includes a breathing gas container array comprising a plurality of separate containers adapted to contain pressurized breathing gas and a manifold in fluid connection with the containers. The manifold includes at least a first section that is movable relative to a second section of the manifold so that at least one container in fluid connection with the first section is movable relative to at least one other container in fluid connection with the second section. In a number of embodiments, each of the containers comprises a plurality of cells in fluid connection via a passageway.

### CROSS-REFERENCE TO RELATED APPLICATION

This application claims benefit of U.S. Provisional Patent Application Ser. No. 61/317,161 filed Mar. 24, 2010, the disclosure of which is incorporated herein by reference.

### BACKGROUND

The following information is provided to assist the reader to understand the technology described below and certain environments in which such technology can be used. The terms used herein are not intended to be limited to any particular narrow interpretation unless clearly stated otherwise in this document. References set forth herein may facilitate understanding of the technology or the background thereof. The disclosure of all references cited herein are incorporated by reference.

A self-contained breathing apparatus (“SCBA”) is a device used to enable breathing in environments which are immediately dangerous to life and health (IDLH). For example, firefighters wear an SCBA when fighting a fire. The SCBA typically has a harness supporting one or more air tanks which is/are connected to a facepiece, all of which are worn or carried by the user. In many commercially available SCBA, relatively large and rigid air tanks limit the movement of the user of the SCBA.

### SUMMARY

In one aspect, a breathing apparatus includes a breathing gas container array comprising a plurality of separate containers adapted to contain pressurized breathing gas and a manifold in fluid connection with the containers. The manifold includes at least a first section that is movable relative to a second section of the manifold so that at least one container in fluid connection with the first section is movable relative to at least one other container in fluid connection with the second section. In a number of embodiments, each of the containers comprises a plurality of cells in fluid connection via a passageway.

The manifold can, for example, include a third section adjacent the second section. The third section is movable relative to the second section so that at least one container in fluid connection with the third section is movable relative to the at least one other container in fluid connection with the second section. The second section can, for example, be intermediate between the first section and the second section. The first section can be connected to the second section via a first flexible high-pressure coupling, and the third section can be connected to the second section via a second flexible high-pressure coupling.

In a number of embodiments, the manifold includes a pressure gauge, a valve and a fitting to connect an outlet hose of the breathing apparatus thereto. The breathing apparatus can further include a first-stage regulator in fluid connection with the outlet hose to reduce pressure from a high pressure within the breathing gas container array to an intermediate pressure and a second-stage regulator in fluid connection with the first-stage pressure regulator to further decrease the pressure. The breathing apparatus can further include a facepiece to which the second-stage regulator is connectible.

In a number of embodiments, the breathing apparatus further includes a plurality of extending supports. Each extending support is placed in operative connection with one of the containers of the breathing gas container array.

In a number of embodiments, the breathing apparatus can further include a flexible cover to encompass at least a portion of the breath gas container array and the manifold. Each of the extending supports can, for example, be positioned between a forward section of the cover and the associated container. The breathing apparatus can, for example, further include a flexible harness to be worn by user, wherein the cover is connectible to the harness.

The technology described herein, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a rear view of an embodiment of a breathing gas supply system of a self-contained breathing apparatus wherein a cover for a breathing gas container array of the system is in an open state.

FIG. 2 illustrates a rear view of the breathing gas supply system wherein the cover for the breathing gas container array of the system is in a closed state.

FIG. 3 illustrates a rear view of the cover for the breathing gas container array of the breathing gas supply system is in an open state wherein the breathing gas container array has been removed.

FIG. 4 illustrates a rear view of the breathing gas container array.

FIG. 5 illustrates a rear view of an embodiment of a support member for use in connection with the breathing gas supply system.

FIG. 6 illustrates a top or end view the support member of FIG. 5.

FIG. 7 illustrates a side view of an embodiment of a self-contained breathing apparatus including the breathing gas supply system of FIG. 1 and a flexible harness to which the breathing gas supply system is attached.

FIG. 8 illustrates a front view of the self-contained breathing apparatus of FIG. 7 wherein a lower portion of the cover for the breathing gas supply system is cut away, showing the breathing gas supply system.

FIG. 9 illustrates a side view of the harness of the self-contained breathing apparatus of FIG. 7.

FIG. 10 illustrates a front view of the harness of the self-contained breathing apparatus of FIG. 7.

FIG. 11 illustrates a front view of an embodiment of a manifold of the breathing gas supply system of FIG. 1.

FIG. 12 illustrates a bottom view of the manifold of FIG. 11.

### DETAILED DESCRIPTION

As used herein and in the appended claims, the singular forms “a,” “an”, and “the” include plural references unless the content clearly dictates otherwise. Thus, for example, reference to “a connector” includes a plurality of such connectors and equivalents thereof known to those skilled in the art, and so forth, and reference to “the connector” is a reference to one or more such connectors and equivalents thereof known to those skilled in the art, and so forth.

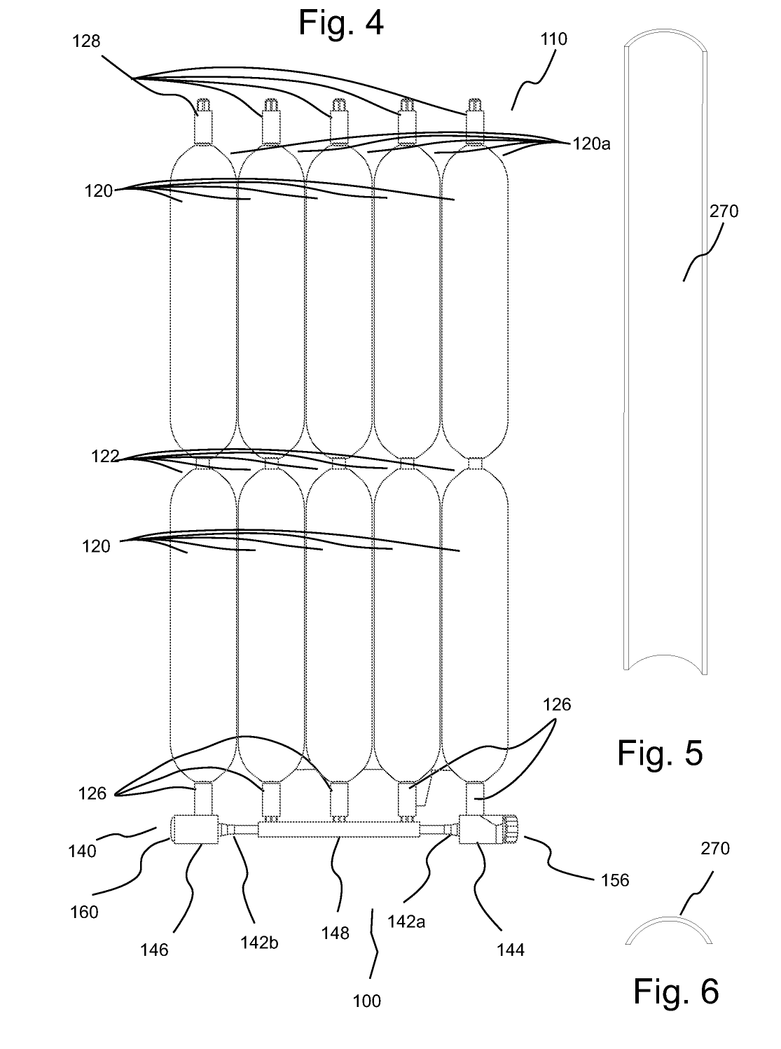

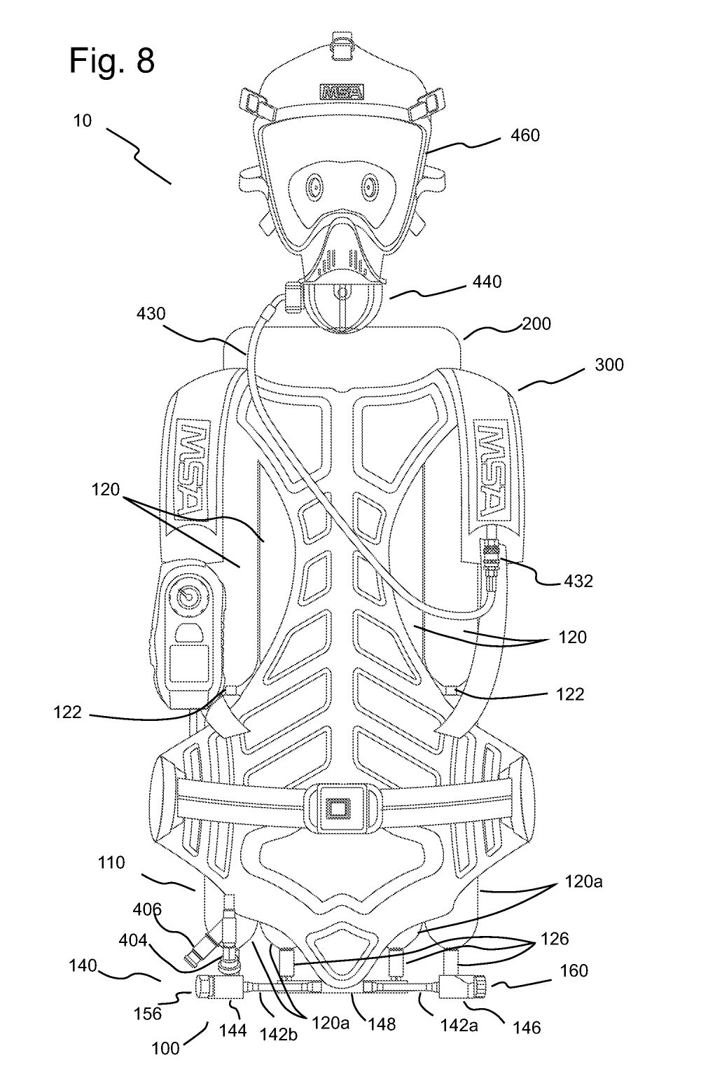

In a number of embodiments hereof, a breathing gas supply system 100 (see, for example, FIG. 4) of a self-contained breathing apparatus (SCBA) 10 (see, for example, FIG. 8) includes a breathing gas container array 110 including of a plurality of or an array of breathing gas (for example, air or oxygen) containers or vessels 120a. Breathing gas container arrays 110 suitable for use herein are, for example, disclosed in U.S. Pat. Nos. 6,648,131, 6,796,421, 7,121,423, and 7,124,908 and 7,131,553 and are available from Vulcore Industrial LLC of Fort Wayne, Ind. In the illustrated embodiment, breathing gas container array 110 includes five vessels or containers 120a wherein each container 120a includes a plurality of cells 120 (two in the illustrated embodiment) connected via a passageway 122 (or a portion of reduced diameter) to form a connected volume or container 120a. Breathing gas container arrays 110 of SCBA 10 can for example, include 3 to 5 containers or vessels 120a. Breathing gas container arrays 110 provide a lower profile than the relatively large single or double tank system often used in commercially available SCBA.

In the illustrated embodiment, each container 120a is in fluid connection with a manifold 140 via a connector 126. In the illustrated embodiment, manifold 140 is positioned at the bottom of breathing gas container array 110. However, manifold 140, could, for example, be positioned at the top or on one of the sides of breathing gas container array 110. As used herein, terms such as “bottom”, “top”, “front”, “rear”, “side” etc. refer generally to the orientation of embodiment of systems hereof as illustrated in the figures and as worn by a user. Such terms related to orientation or position are not intended to be limiting unless the content clearly dictates otherwise. In a number of embodiments, manifold 140 includes one or more flex points or flexible regions which enable connected containers 120a of breathing gas container array 110 to change configuration over a range of configurations. In the illustrated embodiment, manifold 140 includes two flexible regions 142a and 142b in which a flexible, high-pressure coupling (for example, a length of high-pressure hosing) is incorporated into manifold 140 to enable a rigid first section 144 (on one end) and a rigid second section 146 (on an opposite end) of manifold 140 to move over a range of positions relative to a rigid third section 148 positioned intermediate between first section 144 and second section 146. Flexible regions 142a and 142b provide flexibility for containers 120a to move relative to each other to a range of positions or configurations for user comfort and maneuverability in tight spaces while minimizing weight in breathing gas supply system 100.

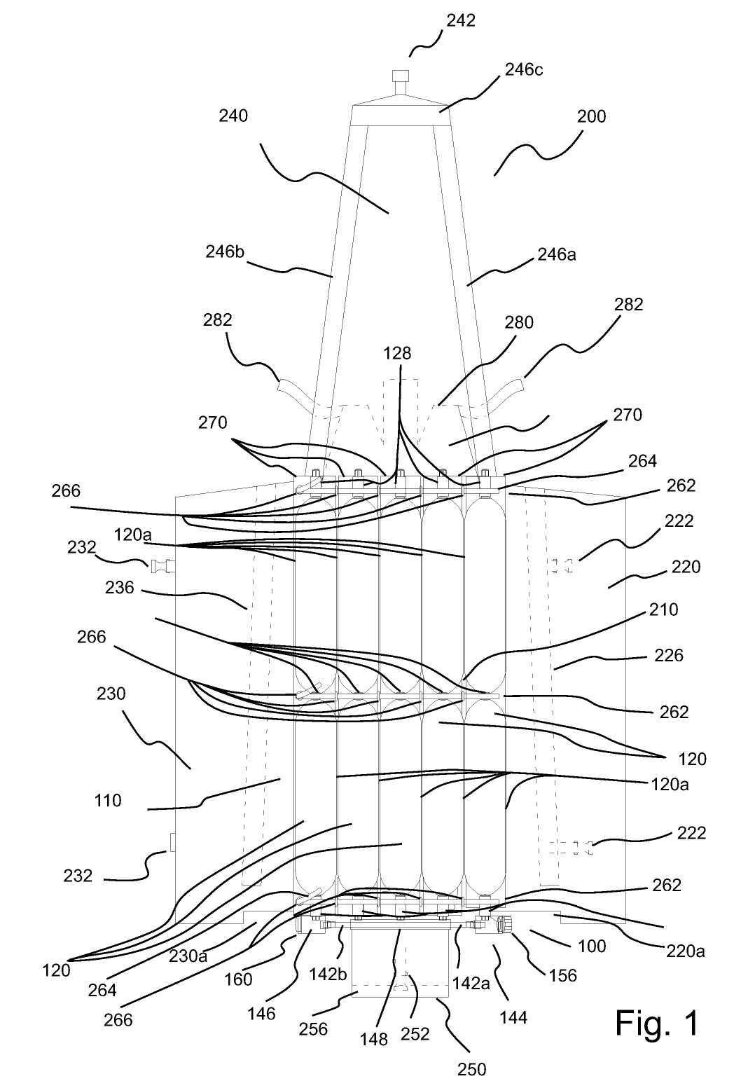

In the illustrated embodiment and with reference to the orientation of FIG. 4 as viewed by the viewer thereof, containers 120a on the right and left sides of breathing gas container array 110, which are in fluid connection with first section 144 and second section 146, respectively, can move out of the plane of the three containers 120a in the center of breathing gas container array 110, which are in fluid connection with intermediate third section 148. In an alternative embodiment, each of containers 120a adjacent to center container 120a can be movable relative thereto and movable relative to right and left end containers 120a. Manifold 140 can, for example, include five separate sections (or as many sections as there are containers), each of which is in fluid connection with one of containers 120a, and wherein the five sections are connected with high-pressure couplings. The inventors have found, however, that the range of configurations provided by breathing gas supply system 100 illustrated, for example, in FIGS. 1 and 4 provides significant ergonomic benefit without the problems that can be associated with having multiple couplings including lengths of high-pressure hosing that are shorter than the hosing lengths of flexible points or regions 142a and 142b.

A number of devices or systems are integrated into the manifold 140 which are currently included as separate (or unconnected) individual components located in the open spaces on commercially-available SCBA. Such components are typically positioned adjacent to the large high pressure cylinder(s) in such commercially-available SCBA. Integrating the functionality of such components in manifold 140 can, for example, reduce weight and profile while providing a system that is field-usable and meets regulatory requirements.

In a number of embodiments, a Compressed Gas Association or CGA fitting 150 (for example, a CGA 347 fitting) is provided on manifold 140. A CGA fitting is a standardized fitting for attachment of a compressed gas container to a required regulator or transfer line. Also integrated within manifold 140, is a cylinder valve 156. In the illustrated embodiment, each of CGA fitting 150 and cylinder valve 156 are integrated within first section 144.

In a number of embodiments, a pressure gauge 160 is integrated within, for example, second section 146 of manifold 140. Pressure gauge 160 can, for example, be a low profile pressure gauge. Integrating pressure gauge 160 into manifold 140 assists in providing protection from damage of pressure gauge 160. In a number of embodiments, a pressure relief mechanism such as a safety burst disc 164 is integrated into, for example, intermediate or third section 148 to provide protection against overpressure.

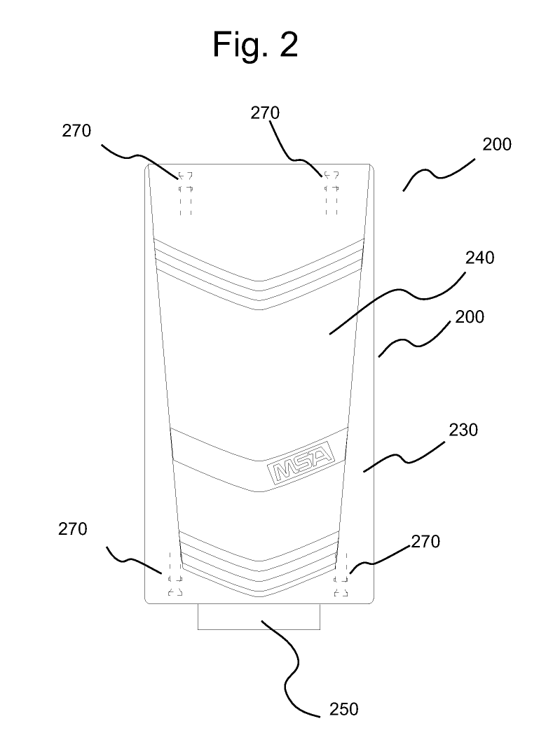

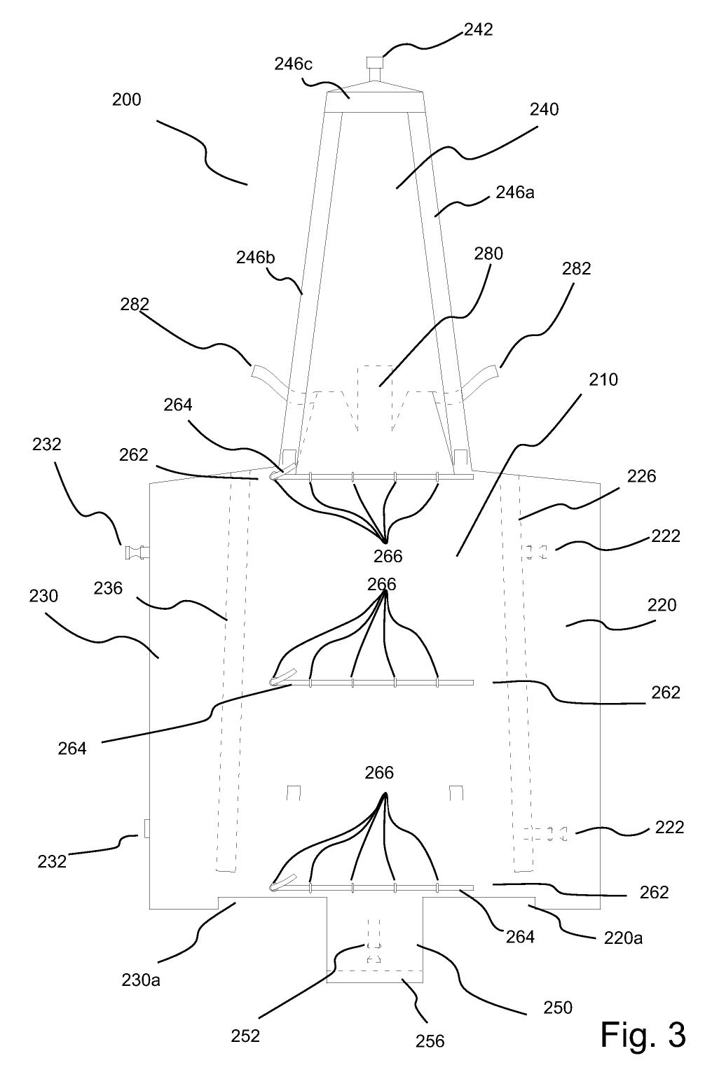

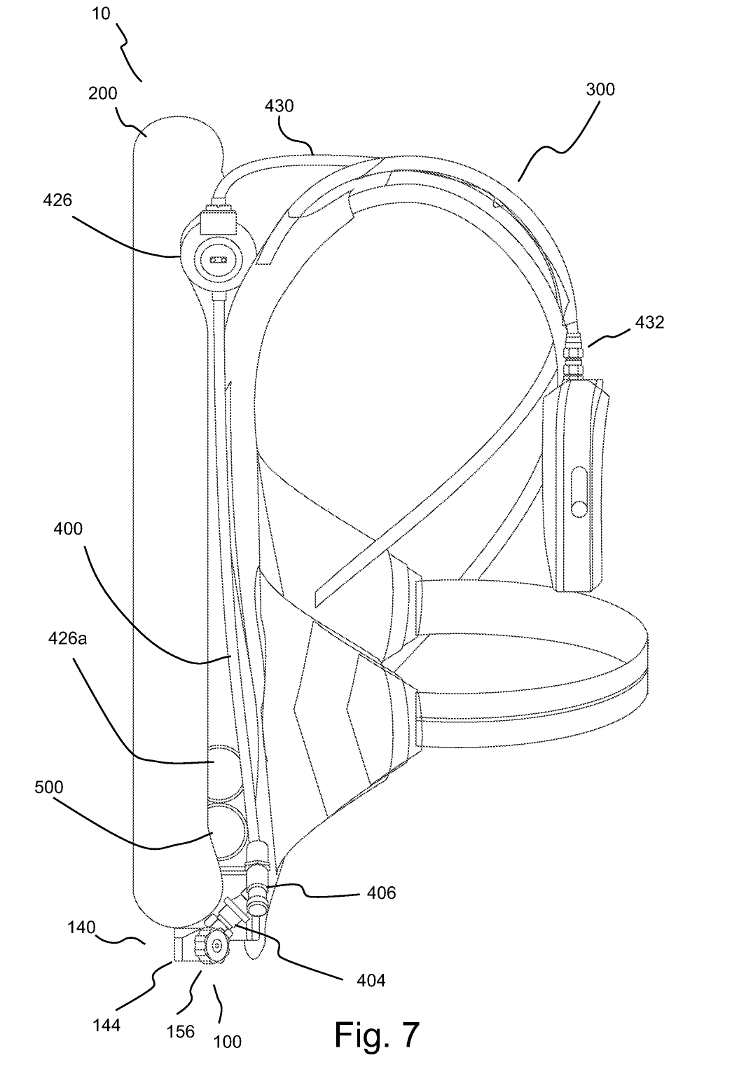

During use in a number of embodiments, breathing gas container array 110 and attached manifold 140 are at least partially contained within a cover 200 as, for example, illustrated in FIGS. 1 through 3 and FIG. 7. Cover 200 includes a base or forward section 210 (referring to the orientation when worn by a user), a first side section 220, a second side section 230, an upper or top section 240 and a lower or bottom section 250. Forward section 210 has attached thereto a number a retainers 262 that can, for example, include a strap 264 which passes around a portion of containers 120a (or an element attached thereto) and through a plurality of connectors 266 (for example, ring connectors) to secure breathing gas container array 110 to cover 200. Two such ring connectors 266 can be provided on one side (the left side with reference to the orientation of FIG. 3) to provide a cinching mechanism to secure strap 264 as known in the cinching arts. As, for example, illustrated in FIG. 1, a strap 264 of a first retainer 262 passes around and secures connectors 126. A strap 264 of a second retainer 262 passes around and secures passageways 122. A strap 264 of a third retainer 262 passes around and secures upper portions 128 of each container 120a. In the illustrated embodiment, side sections 220 and 230 are formed with open regions 220a and 230a so that fitting 150, valve 156 and pressure gauge 160 are visible and accessible (see FIG. 7) when cover is in a closed state as illustrated in FIG. 2 and FIG. 7.

In a number of embodiments, a support 270 is provided for each container 120a. Supports 260 are positioned between containers 120a and forward section 210 and can, for example, extend the full length of container 120a. Supports 270 are formed from a material (for example, a polymeric material such as polyvinyl chloride or acrylonitrile-butadiene-styrene (ABS)) which is more rigid than the flexible material of cover 200 (which can, for example, be formed from fabrics of aramid or meta-aramid fibers such as KEVLAR®, available from E.I. du Pont de Nemours & Company of Wilmington, Del., NOMEX®, available from E.I. du Pont de Nemours & Company of Wilmington etc.) and limit the amount each container 120a can bend in the vicinity of passageway 122. In a number of embodiments, the materials for cover 200 and/or supports 270 are, for example, be flame-resistant, thermally stable, abrasion resistant and electrical insulating. Because separate supports 270 are provided for each container 120a and because of the flexibility provided by first section 144 and second section 146 of manifold 140 relative to third section 148 of manifold 140, cover 200 and breathing gas container array 110 can conform to the back of the user while maintaining a relatively flat profile. As illustrated in FIGS. 5 and 6, supports 270 can, for example be arced or curved to facilitate seating of containers 120a therein. Supports 270 can be interconnected in other embodiments, but supports 270 associated with adjacent containers 120a connected to sections of manifold 140 which are movable relative to each other should provide for relative motion.

Breathing gas supply system 100 (that is, the assembly of breathing gas container array 110 and manifold 140) and cover 200 can, for example, be attached to and removed from a harness 300 (see FIGS. 7 through 10) as a unit via cooperating connectors as known in the art (for example, via connector straps with cooperating connectors such as buckles). Connectors 270, including straps with cooperating buckles, are illustrated in dashed lines in FIG. 2. Such connectors 270 extend from a front surface of first section 210 and cooperate with cooperating connectors (not shown) extending rearward from harness 300. Moreover, breathing gas supply system 100 can be attached to or removed from connection with cover 200 while cover 200 is attached to harness 300. In addition to connectors 270, a section 280 (see, FIGS. 1 and 3) extends forward from cover 200 to cooperate with and connect to the shoulder straps of harness 300 via straps 282. Section 280 can assist in connecting cover 200 to harness 300 and in properly positioning cover 200 relative to harness 300.

To take cover 200 from an open state as illustrated in FIG. 1 to a closed state as illustrated in FIG. 2, first side section 220 is wrapped around a portion of breathing gas container array 110. Then second side section 230 is wrapped around a portion of breathing gas container array 110 and a portion of first side section 220 so that connectors 232 of second side section 230 can be connected to connectors 222 of first side section 220. At this point, lower section 250 is wrapped upward over manifold 140 and over a portion of breathing gas container array 110, and upper section 240 is wrapped downward over a portion of breathing gas container array 110 and over a portion of lower section 250 so that connector 242 of upper section 240 can be connected to connector 252 of lower section 250. Side sections 220 and 230 can, for example, include fasteners 226 and 236, respectively, that cooperate with cooperating fasteners 246a and 246b, respectively, of upper section 240. Likewise, lower section 250 can, for example, include fasteners 246 that cooperates with a cooperating 246c of upper section 240. The above-described fasteners can, for example, be hook-and-loop fasteners such as VELCRO®, available from Velcro USA Inc. of Manchester, N.H.

Cover 200 can, for example, assist in meeting compliance requirements of, for example, the United States Department of Transportation, in the case that a breathing gas container array 110 such as available from Vulcore Industrial LLC is used while providing the flexibility for multiple configurations of breathing gas container array 110.

A high-pressure hose 400 including a female CGA connector 404 to connect to male CAG connector 150 of manifold 140 is operatively connected to harness 300. A Universal Air Connector (UAC) fitting 406 is also in fluid connection with high pressure hose 400 as illustrated, for example, in FIGS. 7 through 10. As set forth in the National Fire Protection Association (NFPA) 1981 standard (2007 edition), UAC fitting 406 is a male fitting which cooperates or connects to a female fitting, affixed to a filling hose, to provide emergency replenishment of breathing air to breathing gas tank array 110 of SCBA 10. UAC fitting 406 is also known as Rapid Intervention Crew/Company (RIC) Universal Air Connection or an RIC/UAC.

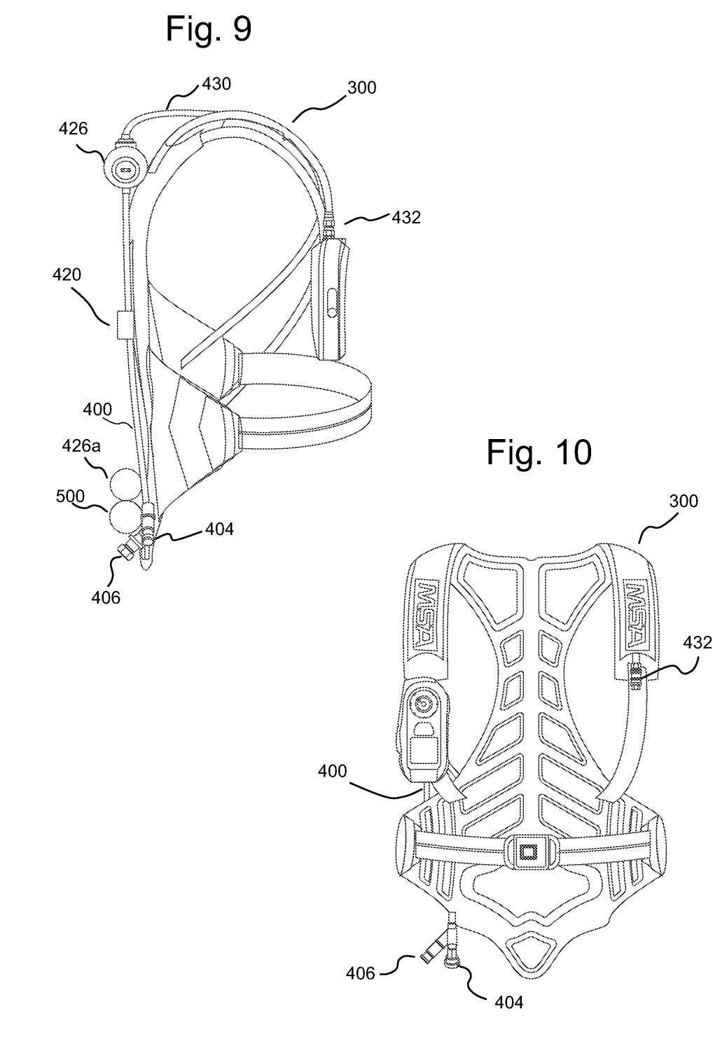

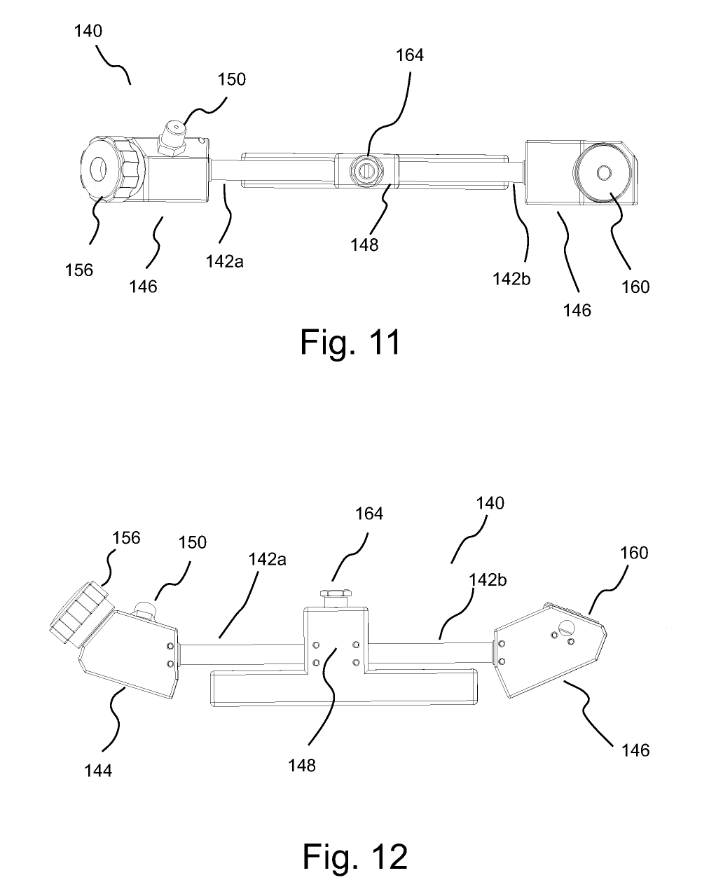

As illustrated, for example, in FIGS. 7 and 9, high-pressure hose 400 extends between cover 200 and harness 300 to a first-stage pressure regulator 420 connected to harness 300. Breathing gas container array 110 contains air or breathing gas under high pressure (for example, in the range of 2200 psi-4500 psi) and is connected to first-stage regulator 420 (see FIG. 9), as known in the art, which reduces the pressure to, for example, about 80 psi. First-stage regulator 420 is in fluid connection with an end of service time indicator (EOSTI) or alarm 426. Alarm 426 can, for example, be an AUDI-LARM™ audible alarm (a low pressure warning device), available from Mine Safety Appliances Company of Pittsburgh, Pa., which can alarm when the remaining service life of the SCBA is reduced to within a predetermined range (for example, within a range of 20 to 25 percent of its rated service time). Alarm 426 (and thereby first-stage regulator 420) is connected to a second-stage regulator 440 via one or more lengths of intermediate pressure hosing 430 and intermediate connector(s) 432. A secondary or redundant low-pressure alarm 426a (for example, an audible piezo sounder of alarm) can, for example, be provided on the lower portion of harness 300.

As known in the art, second stage regulator 440 includes an inlet valve (not shown) which controls the flow of air for breathing between breathing gas container array 110 and a facepiece 460 worn by the user (see FIG. 8). Typically, the inlet valve controls the flow of air through the regulator in response to the respiration of the user. Such respiration-controlled regulator assemblies are disclosed, for example, in U.S. Pat. Nos. 4,821,767 and 5,016,627, the disclosures of which are incorporated herein by reference. Second stage-regulator 440 can, for example, be a FIREHAWK® MMR, available from Mine Safety Appliances Company. Facepiece 460 can, for example, be an ULTRA ELITE facepiece available from Mine Safety Appliances Company.

Components such as the first stage regulator and/or the UAC fitting can alternatively be integrated into manifold 140. However, the integration of too many components into manifold 140 can be detrimental to the goals of maintaining a low profile and maintaining flexibility.

A power module 500 (including, for example, one or more batteries) is also connected to a lower, rear portion of harness 500 as illustrated in FIGS. 7 and 9. Electrically powered components and electrical cabling connecting such components can, for example, be attached to flexible harness 300. Harness 300 includes routings for pressure hoses and electronic cables, compartments or connectors for power module 500 and other electronic components. As described above, harness 300 also includes connectors or attachments (not shown) for the cover 200. In the illustrated embodiment, electronics cables and pneumatic hoses are bundled together along a rear harness 300 and pass through the shoulder strap of harness 300 to keep the SCBA relatively low in profile and to minimize snag hazards. The user can, for example, remove and change out breathing gas supply system 100 without having to remove the electronics from harness 300.

Unlike commercially-available SCBA harnesses, harness 300 does not include a rigid back frame to support an air tank or breathing gas container array 110. As described above, flexing or flexible manifold 140 and supports 270 which are movable relative to each other enable containers 120a of breathing gas container array 110 to articulate or move relative to each other to assume a range of positions or configurations. Also, the elimination of a rigid back frame enables the center of gravity of SCBA 10 to be carried closer to the wearers spine in the as-worn conformation. The elimination of a rigid back frame and the associated range of configurations for breathing gas container array 110 provides for improved ergonomics and comfort as compared to traditional SCBA designs.

The relatively flat profile of breathing gas supply system 100 enable, for example, the ready storage of one or more breathing gas supply systems 100 on, for example, a fire truck or other emergency vehicle. To replace a breathing gas supply system 100 of SCBA 10, a user need only disconnect CGA fitting 150 from connection with high-pressure hose 400 and remove the breathing gas supply system 100 to be replaced from connection with cover 200. A replacement breathing gas supply system 100 is readily placed in operative connection with cover 200 and SCBA 10 as described above. Alternatively, one or more breathing gas supply systems 100 can be stored on, for example, a fire truck or other emergency vehicle with an associated cover 200 thereon. In that case, a cover 200 and a connected breathing gas supply system 100 to be replaced can be removed from SCBA 10 and replaced as a unit.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A breathing apparatus comprising:
a breathing gas container array comprising a plurality of separate containers adapted to contain pressurized breathing gas; and
a manifold in fluid connection with the containers, the manifold comprising at least a first section that is movable relative to a second section of the manifold so that at least one container in fluid connection with the first section is movable relative to at least one other container in fluid connection with the second section.

2. The breathing apparatus of claim 1 wherein each of the containers comprises a plurality of cells in fluid connection via a passageway.

3. The breathing apparatus of claim 1 wherein the manifold comprises a third section adjacent the second section, the third section being movable relative to the second section so that at least one container in fluid connection with the third section is movable relative to the at least one other container in fluid connection with the second section.

4. The breathing apparatus of claim 1 wherein the second section is intermediate between the first section and the second section and the first section is connected to the second section via a first flexible high-pressure coupling and the third section is connected to the second section via a second flexible high-pressure coupling.

5. The breathing apparatus of claim 4 wherein the manifold includes a pressure gauge, a valve and a fitting to connect an outlet hose of the breathing apparatus thereto.

6. The breathing apparatus of claim 5 wherein the breathing apparatus further comprises a first-stage regulator in fluid connection with the outlet hose to reduce pressure from a high pressure within the breathing gas container array to an intermediate pressure and a second-stage regulator in fluid connection with the first-stage pressure regulator to further decrease the pressure, the breathing apparatus further comprising a facepiece to which the second-stage regulator is connectible.

7. The breathing apparatus of claim 4 further comprising a plurality of extending supports, each extending support being placed in operative connection with one of the containers of the breathing gas container array.

8. The breathing apparatus of claim 7 further comprising a flexible cover to encompass at least a portion of the breath gas container array and the manifold, each of the extending supports being positioned between a forward section of the cover and the associated container.

9. The breathing apparatus of claim 8 further comprising a flexible harness to be worn by user, the cover being connectible to the harness.
